(19) United States
(12) Patent Application Publication
(10) Pub. No.: US 2026/0102228 A1
(43) Pub. Date: Apr. 16, 2026

(54) ORAL APPARATUSES AND METHODS FOR MANDIBULAR JAW MANIPULATION

(71) Applicant: Serena Sleep Solutions, Lakeland, MN (US)

(72) Inventor: Gary Maas, Lakeland, MN (US)

(21) Appl. No.: 19/357,403

(22) Filed: Oct. 14, 2025

Related U.S. Application Data
(60) Provisional application No. 63/707,571, filed on Oct. 15, 2024.

(51) Int. Cl. A61C 7/36; A61C 7/08

(52) U.S. Cl. CPC A61C 7/36; A61C 7/08

(57) ABSTRACT

An oral apparatus for controlling the positional relationship between a mandible and maxilla of a patient includes an upper tray configured to receive maxillary teeth and a lower tray configured to receive mandibular teeth. The upper tray has an upper member with a base portion and an interlocking member extending away from the tray, the interlocking member comprising a shoulder and an arm that forms, with the base portion, an upper recess. The lower tray has a lower member with a base portion and an interlocking member extending away from the tray, the interlocking member comprising a shoulder and an arm that forms, with the base portion, a lower recess. The upper arm is received within the lower recess, and the lower arm is received within the upper recess to adjust the mandible-maxilla positional relationship.

### CROSS-REFERENCE TO RELATED APPLICATIONS

This application claims the benefit of and priority to U.S. Provisional Application No. 63/707,571, titled “Oral Apparatuses and Methods for Mandibular Jaw Manipulation”, filed Oct. 15, 2024, the contents of which are incorporated by reference herein.

### TECHNICAL FIELD

The subject matter disclosed herein relates to orthodontics and dentistry and, in particular, to systems and methods that affect the maxillary and mandibular dental relationship of a user.

### BACKGROUND

The relationship between the mandible and maxilla can have a wide range of consequences, affecting for example, chewing, biting, facial alignment, snoring, and/or sleep apnea. The relationship between the mandible and maxilla can be corrected with orthodontic elastics, headgear, or intra-oral bite correctors. These devices can be uncomfortable for the wearer, unaesthetic, and/or require frequent replacement.

### SUMMARY

According to one aspect, an oral apparatus for controlling a positional relationship between a mandible and maxilla of a patient. An upper tray is configured to receive a plurality of maxillary teeth. The upper tray includes an upper member having an upper base portion coupled to the upper tray and an upper interlocking member extending from the upper base portion in a first direction opposite from the upper tray. The upper interlocking member includes an upper shoulder coupled with the upper base portion and an upper arm extending from the upper shoulder. An upper recess is formed between the upper arm and the upper base portion. A lower tray is configured to receive a plurality of mandibular teeth. The lower tray includes a lower member having a lower base portion coupled to the lower tray and a lower interlocking member extending from the lower base portion in a second direction opposite from the lower tray. The lower interlocking member includes a lower shoulder coupled with the lower base portion and a lower arm extending from the lower shoulder. A lower recess is formed between the lower arm and the lower base portion. The upper arm of the upper interlocking member is received within the lower recess of the lower tray and the lower arm of the lower interlocking member is received with the upper recess of the upper tray to adjust the positional relationship between the mandible and the maxilla of the patient.

According to another aspect, an oral apparatus. An upper tray is configured to receive a plurality of maxillary teeth. An upper member including an upper recess and upper base portion is coupled to the upper tray. A lower tray is configured to receive a plurality of mandibular teeth. A lower member including a lower interlocking member and a lower base portion is coupled to the lower tray. The lower interlocking member is slidingly receivable with the upper recess of the upper member to control a positional relationship between a mandible and a maxilla of a patient.

According to another aspect, an oral appartaus. A lower tray is configured to receive a plurality of mandibular teeth. A lower member including a lower recess and a lower base portion is coupled to the lower tray. An upper tray is configured to receive a plurality of maxillary teeth. An upper member including an upper interlocking member and an upper base portion is coupled to the upper tray. The upper interlocking member is slidingly receivable with the lower recess of the lower member to control a positional relationship between a mandible and a maxilla of a patient.

### BRIEF DESCRIPTION OF THE DRAWINGS

FIG. 1 is an isometric side view of an oral apparatus engaged to mandibular teeth and maxillary teeth, according to some embodiments.

FIG. 2A is an isometric side view of an oral apparatus including an upper element engaged with a lower element, according to some embodiments.

FIG. 2B is a magnified side view of an upper member of the upper element engaged with a lower member of the lower element, according to some embodiments.

FIG. 2C is a front view of an oral apparatus including the upper element engaged with the lower element, according to some embodiments.

FIG. 3 is an isometric view of the lower element of the oral apparatus, according to some embodiments.

FIG. 4 is an isometric view of the upper element of the oral apparatus, according to some embodiments.

FIG. 5A is an isolated side view of the upper member engaged with the lower member, according to some embodiments.

FIG. 5B is a side view of the upper member, according to some embodiments.

FIG. 5C is a side view of the lower member, according to some embodiments.

FIG. 6 is a top view of a left-side of the lower element and the lower member, according to some embodiments.

FIG. 7 is an isometric side view of an oral apparatus engaged to mandibular teeth and maxillary teeth, according to another embodiment.

FIG. 8 is an isometric side view of an oral apparatus engaged to mandibular teeth and maxillary teeth, according to yet another embodiment.

### DETAILED DESCRIPTION

The present disclosure describes oral apparatuses, systems, and/or methods for altering or directing the relationship between the mandible and maxilla in an orthodontic manner as the user sleeps. The oral apparatus includes an upper element (or upper tray) configured to secure to maxillary teeth and a lower element (or lower tray) configured to secure to mandibular teeth of the user. An upper member of the upper element engages a lower member of the lower element (and/or vice-versa) such that the mandible and maxilla are locked in relation to each other. The upper member and/or the lower member include interlocking members configured to be received within a channel or slot of one another via a sliding motion. The interlocking members are configured to provide a stable engagement between respective locking surfaces to prevent unintentional disengagement of the upper member from the lower member during sleep. The upper member and the lower member are positioned between the buccal surface and the lingual surfaces of the teeth to reduce discomfort and/or visibility of the oral apparatus.

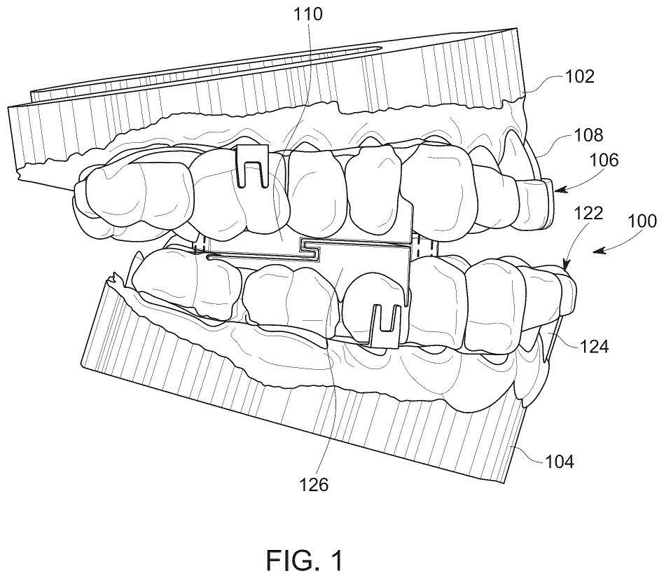

FIG. 1 is an isometric side view of an oral apparatus 100 engaged with mandibular teeth 124 of a mandible 104 and maxillary teeth 108 of a maxilla 102, according to some embodiments. The oral apparatus 100 includes an upper tray 106 and a lower tray 122 configured to receive and secure to the maxillary teeth 108 and the mandibular teeth 124, respectively. The upper tray 106 includes an upper member 110 and/or the lower tray 122 includes a lower member 126, according to some embodiments. The upper member 110 is slidably couplable to the lower member 126 such that a positional relationship between the maxilla 102 and the mandible 104 is controlled, i.e., during the patient's sleep.

The upper tray 106 includes a generally U-shaped arch with one or more tooth depressions which may extend into the upper tray 106, according to some embodiments. The shape of the arch corresponds to the maxillary dental arch of the user. Each tooth depression may be configured to receive one or more surfaces of a tooth such as the distal surface, mesial surface, palatal surface, the buccal surface, and/or the occlusal surface. The tooth depressions are at least sufficiently wide and deep to be able to frictionally fit (or force fit) the teeth of the patient, thereby allowing the upper tray 106 to engage or secure to one or more maxillary teeth when at least a portion of the maxillary teeth 108 are received in the tooth depressions.

The lower tray 122 includes a generally U-shaped arch with one or more tooth depressions which may extend into the lower tray 122, according to some embodiments. The shape of the arch corresponds to the mandibular dental arch of the user. Each tooth depression may be configured to receive one or more surfaces of a tooth such as the distal surface, mesial surface, palatal surface, the buccal surface, and/or the occlusal surface. The tooth depressions are at least sufficiently wide and deep to be able to frictionally fit (or force fit) the teeth of the patient, thereby allowing the lower tray 122 to engage or secure to one or more mandibular teeth when at least a portion of the mandibular teeth 124 are received in the tooth depressions. In some embodiments, the upper member 110 and/or the lower member 126 are positioned on the molar and premolar tooth depressions. In some embodiments, the upper member 110 and/or the lower member 126 are positioned entirely rearward (or distal) from a canine tooth depression.

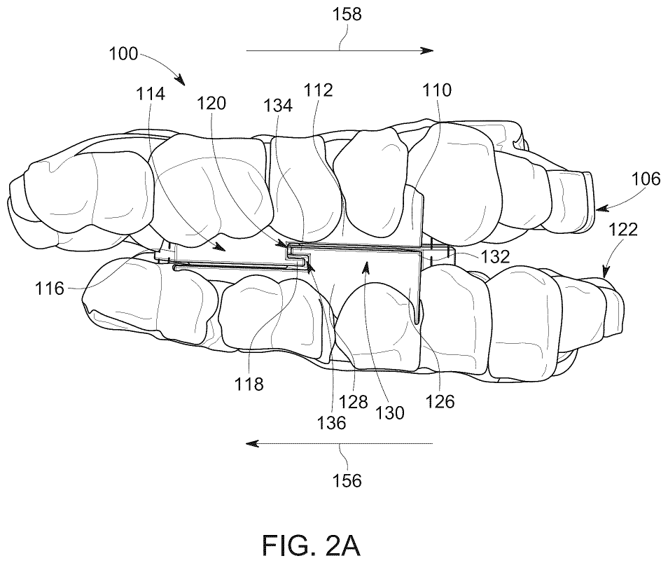

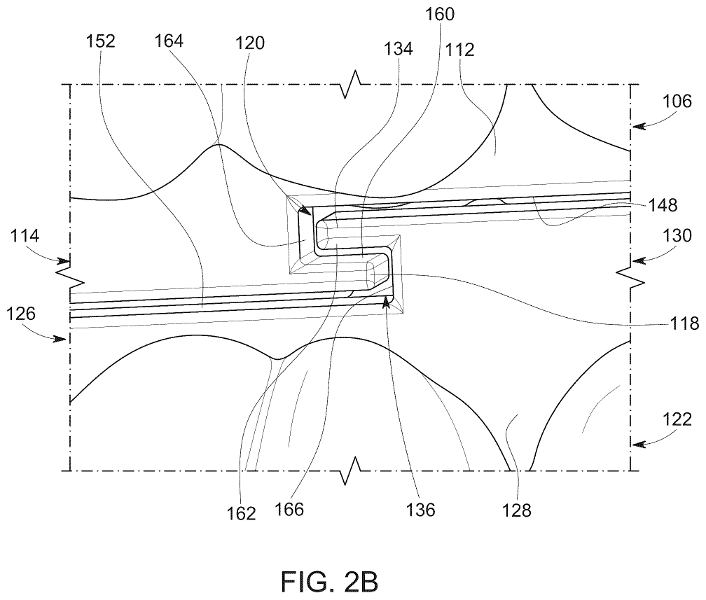

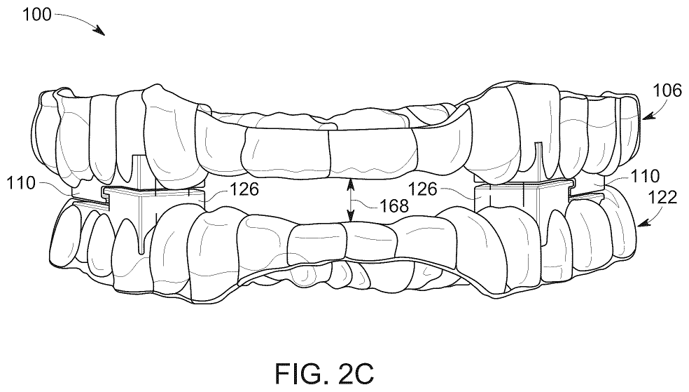

FIG. 2A is an isometric side view of the oral apparatus 100 including the upper member 110 engaged with the lower member 126, according to some embodiments. FIG. 2B is a magnified side view of the upper member 110 engaged with the lower member 126, according to some embodiments. FIG. 2C is a front view of the oral apparatus 100 including the upper member 110 engaged with the lower member 126, according to some embodiments.

The upper member 110 includes an upper base portion 112 and an upper interlocking member 114 having an upper shoulder 116, an upper arm 118, and an upper recess 120, according to some embodiments. The upper member 110 is secured to the upper tray 106, and in some embodiments, the upper base portion 112 is coupled to the upper tray 106. The upper interlocking member 114 extends from the upper base portion 112 in a direction opposite from the upper tray 106. The upper interlocking member 114 includes the upper shoulder 116 which extends from the upper base portion 112. The upper arm 118 extends from the upper shoulder 116 in a mesial direction 158 (i.e., toward the front teeth or incisors). The upper arm 118 is cantilevered, i.e., supported on one end and unsupported on another end. The upper recess 120 is formed between the upper arm 118 and the upper base portion 112. In some embodiments, the upper recess 120 is formed between a first surface 148 of the upper base portion 112 and an upper arm engagement surface 160 of the upper arm 118. The upper recess 120 includes an upper stop surface 164, and in some embodiments, the upper recess 120 is bounded by the first surface 148, the upper arm engagement surface 160, and the upper stop surface 164.

The lower member 126 includes a lower base portion 128 and a lower interlocking member 130 having a lower shoulder 132, a lower arm 134, and a lower recess 136, according to some embodiments. The lower member 126 is secured to the lower tray 122, and in some embodiments, the lower base portion 128 is coupled to the lower tray 122. The lower interlocking member 130 extends from the lower base portion 128 in a direction opposite from the lower tray 122. The lower interlocking member 130 includes the lower shoulder 132 which extends from the lower base portion 128. The lower arm 134 extends from the lower shoulder 132 in a distal direction 156 (i.e., toward the molars or temporomandibular joint). The lower arm 134 is cantilevered, i.e., supported on one end and unsupported on another end. The lower recess 136 is formed between the lower arm 134 and the lower base portion 128. In some embodiments, the lower recess 136 is formed between a second surface 152 of the lower base portion 128 and a lower arm engagement surface 162 of the lower arm 134. The lower recess 136 includes a lower stop surface 166, and in some embodiments, the lower recess 136 is bounded by the second surface 152, the lower arm engagement surface 162, and the lower stop surface 166.

In some embodiments, the upper arm 118 of the upper interlocking member 114 is received with the lower recess 136 of the lower interlocking member 130 and/or the lower arm 134 of the lower interlocking member 130 is received within the upper recess 120 of the upper interlocking member 114. For instance, the patient may move the mandible 104 in the mesial direction 158 (such that the upper arm 118 and the lower arm 134 are free of each other), bite down, and slide the mandible 104 in the distal direction 156 to engage the upper interlocking member 114 with the lower interlocking member 130, thereby securing the position of the maxilla 102 relative to the mandible 104. A gap 168 between the maxillary teeth 108 and the mandibular teeth 124 (and thereby the maxilla 102 and mandible 104) is maintained by the engagement between the upper member 110 and the lower member 126, according to some embodiments. The size of the gap 168 can be controlled via custom fabrication of the upper member 110 and the lower member 126, i.e., the height of the upper base portion 112, the lower base portion 128, the upper interlocking member 114, and/or the lower interlocking member 130 determine the magnitude of the gap 168. The oral apparatus 100 is configured to control a vertical relationship between the maxilla 102 and the mandible 104 (as indicated by the gap 168) via the upper arm engagement surface 160 engaging the lower arm engagement surface 162, the first surface 148 engaging the first engagement surface 170 and/or the second surface 152 engaging the second engagement surface 172. Travel of the mandible 104 in the distal direction 156 is limited (or controlled) via engagement between the lower arm 134 and the upper stop surface 164 and/or the upper arm 118 and the lower stop surface 166. Thus, the oral apparatus is configured to control both vertical positioning and distal positioning of the mandible 104 relative to the maxilla 102, which thereby improves a patient's sleep.

In some embodiments, the upper arm engagement surface 160 engages the lower arm engagement surface 162 to limit travel of the mandible 104 relative to the maxilla 102, i.e., the patient cannot open/close the mouth during sleep when the upper arm engagement surface 160 is engaged with the lower arm engagement surface 162. In some embodiments, the lower arm 134 extends parallel to the second surface 152 and/or the upper arm 118 extends parallel to the first surface 148. The upper arm engagement surface 160 is parallel with the lower arm engagement surface 162, according to some embodiments. The second surface 152 engages the upper interlocking member 114 and/or the first surface 148 engages the lower interlocking member 130 to maintain the gap 168, according to some embodiments. In some embodiments, the first surface 148 is oriented parallel to the second surface 152.

Receiving the upper arm 118 of the upper interlocking member 114 within the lower recess 136 of the lower interlocking member 130 and/or the lower arm 134 of the lower interlocking member 130 within the upper recess 120 of the upper interlocking member 114 is beneficial, as it provides a stable engagement between respective locking surfaces to prevent unintentional disengagement of the upper member 110 from the lower member 126 during sleep. For example, to disengage the upper member 110 from the lower member 126, the patient must move the mandible 104 in the mesial direction 158. Movement of the mandible 104 in the mesial direction 158 is limited by the structures and features of the jaw, and unintentional movement of the mandible 104 in the mesial direction 158 during sleep is highly unlikely. Further, the length of overlap between the upper arm 118 and the lower arm 134 (and/or depth of the recesses 120, 136) can be configured to prevent unintentional disengagement.

As shown in FIG. 2C, the oral apparatus 100 may include more than one upper member 110 and lower member 126, i.e., a right upper member, a left upper member, a right lower member, and a left lower member. Providing the upper member 110 and the lower member 126 on both sides of the mouth provides a stable engagement between respective locking surfaces to prevent unintentional disengagement and/or provides an increased engagement surface to distribute forces from jaw clenching. In some embodiments, the upper member 110 and/or the lower member 126 extend across the arch of the mouth, i.e., to the right and left sides of the mouth such that a continuous bite plane is formed around the arch of the mouth. Increasing the surface area of the bite plane distributes load forces from jaw clenching, and in some cases, limits airflow through the jaw to encourage nose breathing during sleep.

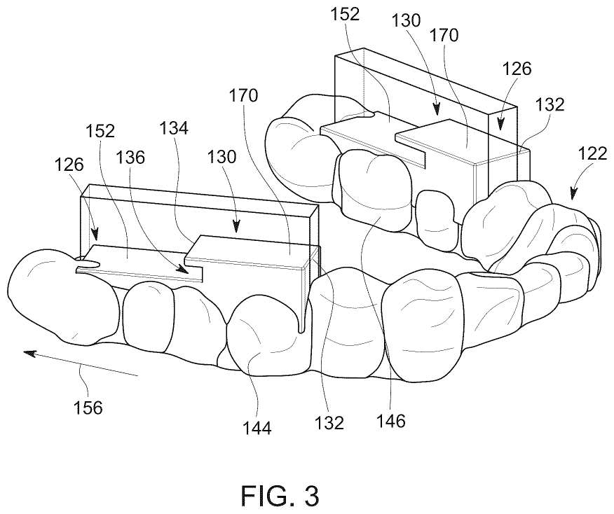

FIG. 3 is an isometric view of the lower tray 122 of the oral apparatus 100, according to some embodiments. The lower tray 122 includes a buccal surface 144 and a lingual surface 146. The lower member 126 is positioned entirely between the buccal surface 144 and the lingual surface 146, i.e., no portion of the lower member 126 extends past a plane of the buccal surface 144 or a plane of the lingual surface 146. Positioning the lower member 126 entirely between the buccal surface 144 and the lingual surface 146 is beneficial because it reduces discomfort and/or visibility of the oral apparatus 100. If, for instance, the lower member 126 extended past a plane of the buccal surface 144 or a plane of the lingual surface 146, the patient may experience discomfort from the lower member 126 extending into the tongue cavity or cheek.

The lower member 126 includes the lower interlocking member 130 having an engagement surface 170. The engagement surface 170 is configured to engage with the upper base portion 112 of the upper member 110, according to some embodiments. The engagement surface 170 is oriented parallel to the second surface 152, and in some embodiments, the lower stop surface 166 is oriented orthogonal to the engagement surface 170.

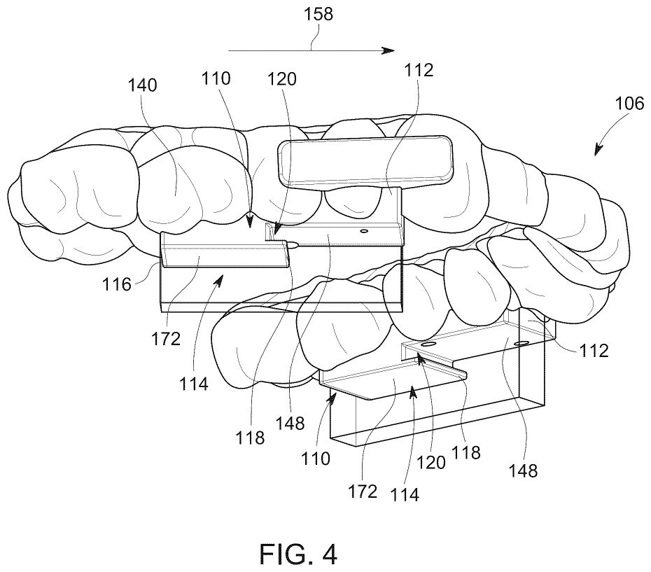

FIG. 4 is an isometric view of the upper tray 106 of the oral apparatus 100, according to some embodiments. The upper tray 106 includes a buccal surface 140 and a lingual surface 142. The upper member 110 is positioned entirely between the buccal surface 140 and the lingual surface 142, i.e., no portion of the upper member 110 extends past a plane of the buccal surface 140 or a plane of the lingual surface 142. Positioning the upper member 110 entirely between the buccal surface 140 and the lingual surface 142 is beneficial because it reduces discomfort and/or visibility of the oral apparatus 100. If, for instance, the upper member 110 extended past a plane of the buccal surface 140 or a plane of the lingual surface 142, the patient may experience discomfort from the upper member 110 extending into the tongue cavity or cheek.

The upper member 110 includes the upper interlocking member 114 having an engagement surface 172. The engagement surface 172 is configured to engage with the lower base portion 128 of the lower member 126, according to some embodiments. The engagement surface 172 is oriented parallel to the first surface 148, and in some embodiments, the upper stop surface 164 is oriented orthogonal to the engagement surface 172.

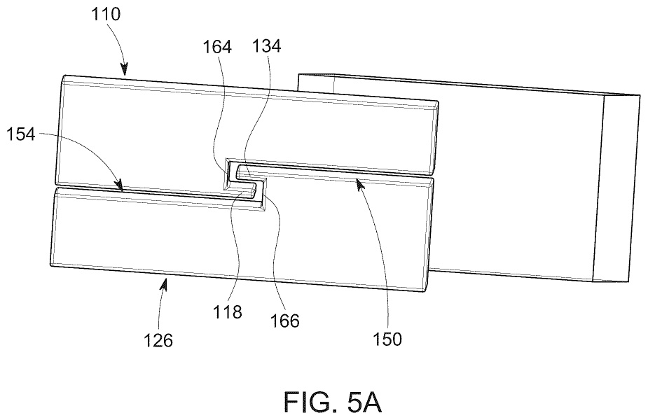

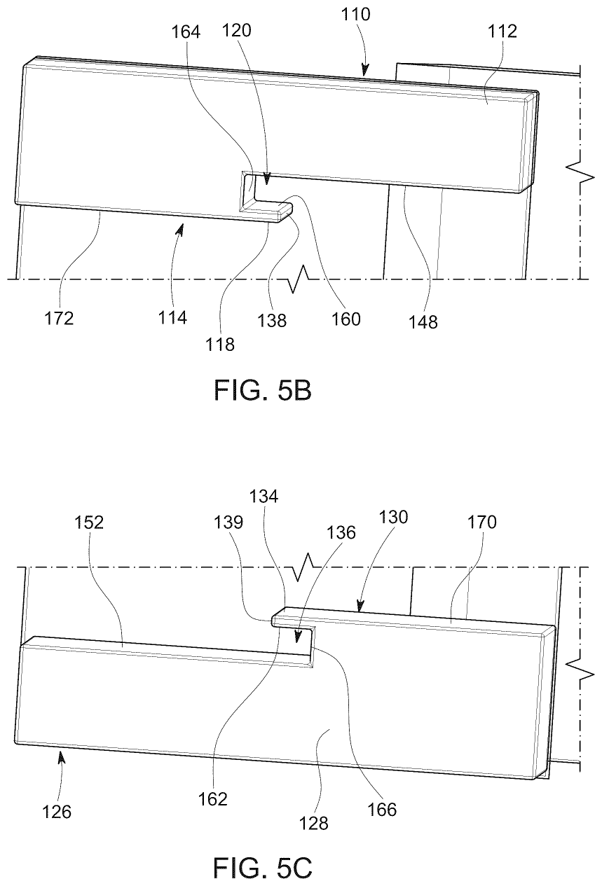

FIG. 5A is an isolated side view of the upper member 110 engaged with the lower member 126, according to some embodiments. FIG. 5B is a side view of the upper member 110, according to some embodiments. FIG. 5C is a side view of the lower member 126, according to some embodiments. The upper interlocking member 114 of the upper member 110, and in particular, the upper arm 118, includes a cantilevered end 138 which is unsupported by the upper interlocking member 114. The cantilevered end 138 extends over the upper recess 120, according to some embodiments. The cantilevered end 138 extends parallel with the first surface 148 of the upper base portion 112, and in some embodiments, the cantilevered end 138 extends perpendicular from the upper stop surface 164. The cantilevered end 138 may include a corner angle of 90°, according to some embodiments. The lower interlocking member 130 of the lower member 126, and in particular, the lower arm 134, includes a cantilevered end 139 which is unsupported by the lower interlocking member 130. The cantilevered end 139 extends over the lower recess 136, according to some embodiments. The cantilevered end 139 extends parallel with the second surface 152 of the lower base portion 128, and in some embodiments, the cantilevered end 139 extends perpendicular from the lower stop surface 166. The cantilevered end 139 may include a corner angle of 90°, according to some embodiments.

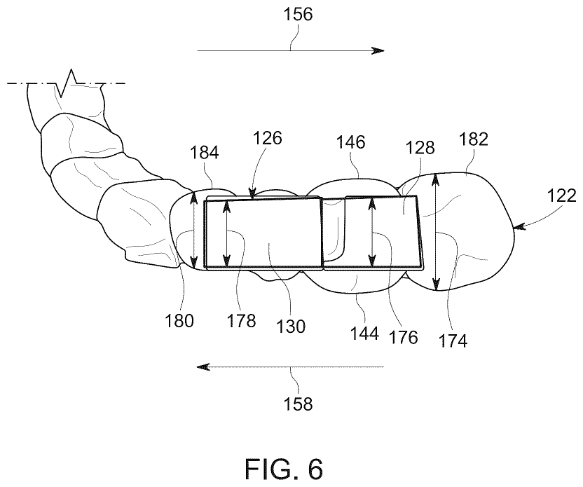

FIG. 6 is a top view of a left-side of the lower tray 122 and the lower member 126, according to some embodiments. The lower tray 122 includes a molar depression 182 and a premolar depression 184. In some embodiments, a distance 174 between the buccal surface 144 and the lingual surface 146 of the molar depression 182 is greater than a width 176 of the lower base portion 128. A distance 180 between the buccal surface 144 and the lingual surface 146 of the premolar depression 184 is greater than a width 178 of the lower member lower interlocking member 130, according to some embodiments. As shown in FIG. 6, in some embodiments, the lower member 126 is positioned entirely between the buccal surface 144 and the lingual surface 146 of the lower tray 122. The maximum width of the lower member 126 (i.e., the greater of the width 176 and the width 178) is less than a minimum distance between the buccal surface 144 and the lingual surface 146 of the lower tray 122, according to some embodiments. It should be noted that the features of the lower tray 122 described above may likewise apply to the upper tray 106, i.e., the maximum width of the upper member 110 is less than a minimum distance between the buccal surface 140 and the lingual surface 142, according to some embodiments.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment(s) disclosed, but that the invention will include all embodiments falling within the scope of the appended claims.

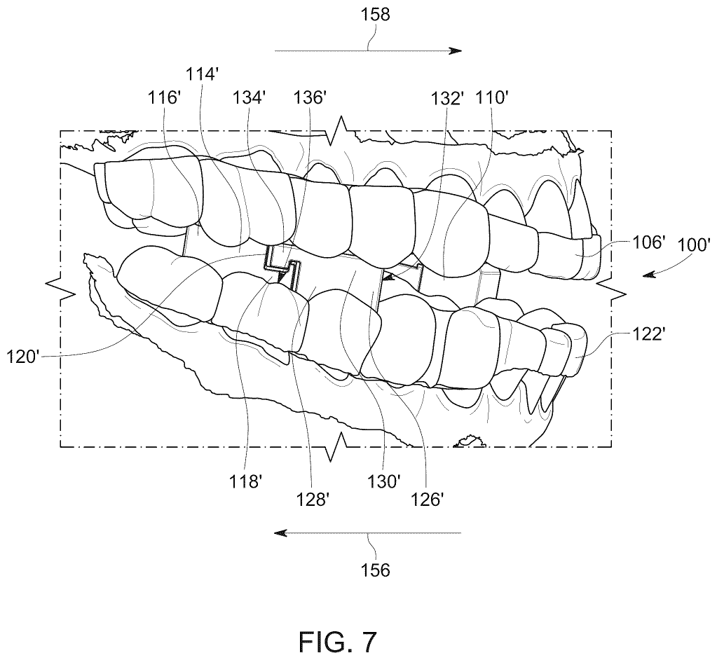

FIG. 7 is an isometric side view of another oral apparatus 100′, similar to the oral apparatus 100, which includes an upper member 110′ engaged with a lower member 126′. The upper member 110′ includes an upper interlocking member 114′ having an upper shoulder 116′, an upper arm 118′, and an upper recess 120′, according to some embodiments. The upper member 110′ is secured to the upper tray 106′. The upper interlocking member 114′ includes the upper shoulder 116′. The upper arm 118′ extends from the upper shoulder 116′ in a mesial direction 158 (i.e., toward the front teeth or incisors). The upper arm 118′ is cantilevered, i.e., supported on one end and unsupported on another end. The upper recess 120′ forms a J-shaped hook feature.

The lower member 126′ includes a lower base portion 128′ and a lower interlocking member 130′ having a lower shoulder 132′, a lower arm 134′, and a lower recess 136′, according to some embodiments. The lower member 126′ is secured to the lower tray 122′, and in some embodiments, the lower base portion 128′ is coupled to the lower tray 122′. The lower interlocking member 130′ extends from the lower base portion 128′ in a direction opposite from the lower tray 122′. The lower interlocking member 130′ includes the lower shoulder 132′ which extends from the lower base portion 128′. The lower arm 134′ extends from the lower shoulder 132′′ in a distal direction 156 (i.e., toward the molars or temporomandibular joint). The lower arm 134′ is cantilevered, i.e., supported on one end and unsupported on another end. The lower recess 136′ is formed between the lower arm 134′ and the lower base portion 128′. The lower recess 136′ forms another J-shaped hook feature that is configured to engage the J-shaped hook feature of the upper arm 118′.

In some embodiments, the J-shaped hook feature of the upper arm 118′ of the upper interlocking member 114′ is received with the lower recess 136′ of the lower interlocking member 130′ and/or the J-shaped hook feature of the lower arm 134′ of the lower interlocking member 130′ is received within the upper recess 120′ of the upper interlocking member 114′. For instance, the patient may engage the J-shaped hook feature of the upper arm 118′ of the upper interlocking member 114′ in the lower recess 136′ of the lower interlocking member 130′ and/or the J-shaped hook feature of the lower arm 134′ of the lower interlocking member 130′ in the upper recess 120′ of the upper interlocking member 114′ by moving the upper tray 106′ along a lateral direction relative to the lower tray 122′, thereby securing the position of the maxilla relative to the mandible. As used herein, the lateral direction is generally perpendicular to the distal and mesial directions 156, 158.

Receiving the upper arm 118′ of the upper interlocking member 114′ within the lower recess 136′ of the lower interlocking member 130′ and/or the lower arm 134′ of the lower interlocking member 130′ within the upper recess 120 of the upper interlocking member 114′ along a lateral direction is beneficial, as it provides a stable engagement between respective locking surfaces to prevent unintentional disengagement of the upper member 110′ from the lower member 126′ during sleep. The J-shaped hooks of the upper arms 118′ and the lower arm 134′ cooperate to prevent to disengagement of the upper member 110′ from the lower member 126′ if the patient moves the mandible in the mesial direction 158. Movement of the mandible in the mesial direction 158 is limited by the J-shaped hooks. Other benefits include a freedom of lateral movement when the upper interlocking member 114′and the lower interlocking member 130′ are interlocked. This freedom of lateral movement promotes patient acceptance and comfort with the oral apparatus 100′. Additionally, when interlocked, precise vertical separation of the upper member 110′ and the lower member 126′ is maintained.

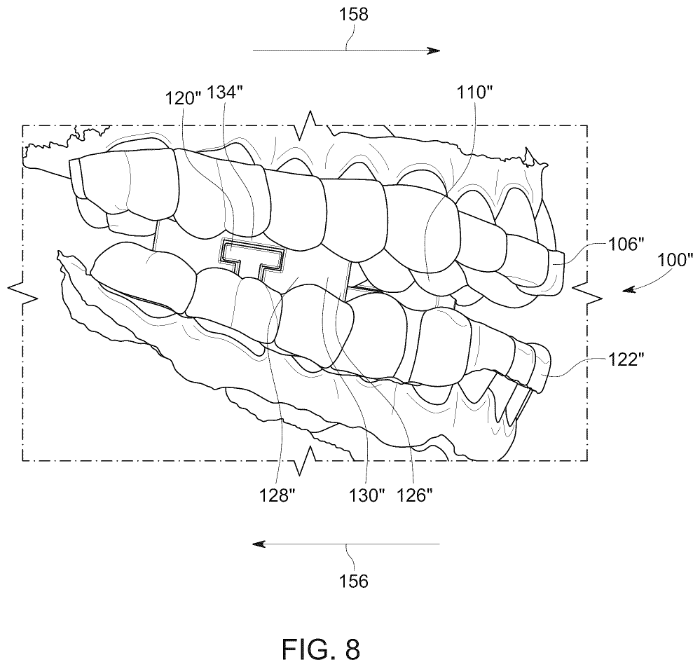

FIG. 8 is an isometric side view of yet another oral apparatus 100′, similar to the oral apparatuses 100 and 100′, which includes an upper member 110′ engaged with a lower member 126′. The upper member 110′ includes a T-shaped upper recess 120′.

The lower member 126′ includes a lower base portion 128′ and a lower interlocking member 130′ having a T-shaped lower arm 134′. The lower interlocking member 130′ extends from the lower base portion 128′ in a direction opposite from the lower tray 122′.

In some embodiments, the T-shaped lower arm 134′ is received with the T-shaped upper recess 120′. For instance, the patient may engage the T-shaped lower arm 134′ in the T-shaped upper recess 120′ along a lateral direction relative to the lower tray 122′, thereby securing the position of the maxilla relative to the mandible. As used herein, the lateral directions is generally perpendicular to the distal and mesial directions 156, 158.

Receiving the T-shaped lower arm 134′ in the T-shaped upper recess 120′ along a lateral direction is beneficial, as it provides a stable engagement between respective locking surfaces to prevent unintentional disengagement of the upper member 110′ from the lower member 126′ during sleep. The T-shaped lower arm 134′ and the T-shaped upper recess 120′ cooperate to prevent to disengagement of the upper member 110′ from the lower member 126′ if the patient move the mandible 104 in the mesial direction 158. Movement of the mandible in the mesial direction 158 is limited by the T-shaped lower arm 134′ and the T-shaped upper recess 120′. The oral apparatus 100′ may also provide a smaller gap 168 between the maxillary teeth and the mandibular teeth (and thereby the maxilla and mandible) than other oral apparatuses. Other benefits include a freedom of lateral movement when the upper interlocking member 114′ nd the lower interlocking member 130′ are interlocked. This freedom of lateral movement promotes patient acceptance and comfort with the oral apparatus 100′. Additionally, when interlocked, precise vertical separation of the upper member 110′ and the lower member 126′ is maintained.

### Discussion of Possible Embodiments

The following are non-exclusive descriptions of possible embodiments of the present invention.

In some aspects, the techniques described herein relate to an oral apparatus for controlling a positional relationship between a mandible and maxilla of a patient. The oral apparatus includes an upper tray configured to receive a plurality of maxillary teeth. The upper tray includes an upper member having an upper base portion coupled to the upper tray and an upper interlocking member extending from the upper base portion in a first direction opposite from the upper tray. The upper interlocking member includes an upper shoulder coupled with the upper base portion and an upper arm extending from the upper shoulder. An upper recess is formed between the upper arm and the upper base portion. The oral apparatus also includes a lower tray configured to receive a plurality of mandibular teeth. The lower tray includes a lower member having a lower base portion coupled to the lower tray and a lower interlocking member extending from the lower base portion in a second direction opposite from the lower tray. The lower interlocking member includes a lower shoulder coupled with the lower base portion and a lower arm extending from the lower shoulder. A lower recess is formed between the lower arm and the lower base portion. The upper arm of the upper interlocking member is received within the lower recess of the lower tray and the lower arm of the lower interlocking member is received with the upper recess of the upper tray to adjust the positional relationship between the mandible and the maxilla of the patient.

The oral apparatus of the preceding paragraph can optionally include, additionally and/or alternatively any, one or more of the following features/steps, configurations, and/or additional components.

For example, the upper arm of the upper interlocking member may be cantilevered.

For example, the upper interlocking member may be positioned entirely between a buccal surface and a lingual surface of the upper tray.

For example, the lower member may be positioned entirely between a buccal surface and a lingual surface of mandibular teeth.

For example, a first surface of the upper base portion may define an upper bite plane and a second surface of the lower base portion defines a lower bite plane. The upper bite plane may engage the lower interlocking member and the lower bite plane may engage the upper interlocking member.

For example, the lower arm may slidingly engage the first surface of the upper base portion.

For example, the upper bite plane may be parallel with the lower bite plane.

For example, the upper arm may extend parallel to the upper bite plane and the lower arm may extend parallel to the lower bite plane.

For example, the lower arm may extend in a distal direction, and the upper arm may extend in a mesial direction opposite to the distal direction.

For example, the upper arm may include an upper arm engagement surface, and the lower arm may include a lower arm engagement surface configured to engage with the upper arm engagement surface to control the positional relationship between the mandible and the maxilla of the patient.

For example, the upper arm engagement surface may be parallel with the lower arm engagement surface.

In some aspects, the techniques described herein relate to an oral apparatus, including an upper tray configured to receive a plurality of maxillary teeth, an upper member including an upper base portion coupled to the upper tray and an upper recess, a lower tray configured to receive a plurality of mandibular teeth, and a lower member including a lower base portion coupled to the lower tray and a lower interlocking member. The lower interlocking member is slidingly receivable with the upper recess of the upper member to control a positional relationship between a mandible and a maxilla of a patient.

The oral apparatus of the preceding paragraph can optionally include, additionally and/or alternatively any, one or more of the following features/steps, configurations, and/or additional components.

In some aspects, the techniques described herein relate to an oral apparatus, wherein the lower interlocking member is positioned entirely between a buccal surface and a lingual surface of the lower tray.

For example, the lower interlocking member may include an arm that is cantilevered, wherein the arm extends in a distal direction.

For example, the arm may include an arm engagement surface, and the upper recess may include a recess engagement surface configured to engage with the arm engagement surface to control the positional relationship between the mandible and the maxilla of the patient.

For example, a first surface of the upper base portion may define an upper bite plane, and a second surface of the lower base portion defines a lower bite plane, and the upper bite plane may engage the lower interlocking member.

For example, an arm of the lower interlocking member may slidingly engage the first surface of the upper base portion.

For example, the upper bite plane may be parallel with the lower bite plane.

For example, the arm of the lower interlocking member may extend parallel to the upper bite plane.

In some aspects, the techniques described herein relate to an oral apparatus, including a lower tray configured to receive a plurality of mandibular teeth, a lower member including a lower base portion coupled to the lower tray and a lower recess, and an upper tray configured to receive a plurality of maxillary teeth; and an upper member including an upper base portion coupled to the upper tray and a upper interlocking member. The upper interlocking member is slidingly receivable with the lower recess of the lower member to control a positional relationship between a mandible and a maxilla of a patient.

1. An oral apparatus for controlling a positional relationship between a mandible and maxilla of a patient, the oral apparatus comprising:
an upper tray configured to receive a plurality of maxillary teeth, the upper tray including an upper member having an upper base portion coupled to the upper tray and an upper interlocking member extending from the upper base portion in a first direction opposite from the upper tray, the upper interlocking member including an upper shoulder coupled with the upper base portion and an upper arm extending from the upper shoulder, wherein an upper recess is formed between the upper arm and the upper base portion; and
a lower tray configured to receive a plurality of mandibular teeth, the lower tray including a lower member having a lower base portion coupled to the lower tray and a lower interlocking member extending from the lower base portion in a second direction opposite from the lower tray, the lower interlocking member including a lower shoulder coupled with the lower base portion and a lower arm extending from the lower shoulder, wherein a lower recess is formed between the lower arm and the lower base portion,
wherein the upper arm of the upper interlocking member is received within the lower recess of the lower tray, and the lower arm of the lower interlocking member is received with the upper recess of the upper tray to adjust the positional relationship between the mandible and the maxilla of the patient.

2. The oral apparatus of claim 1, wherein the upper arm of the upper interlocking member is cantilevered.

3. The oral apparatus of claim 1, wherein the upper interlocking member is positioned entirely between a buccal surface and a lingual surface of the upper tray.

4. The oral apparatus of claim 1, wherein the lower member is positioned entirely between a buccal surface and a lingual surface of mandibular teeth.

5. The oral apparatus of claim 1, wherein a first surface of the upper base portion defines an upper bite plane, and a second surface of the lower base portion defines a lower bite plane, wherein the upper bite plane engages the lower interlocking member, and the lower bite plane engages the upper interlocking member.

6. The oral apparatus of claim 5, wherein the lower arm slidingly engages the first surface of the upper base portion.

7. The oral apparatus of claim 6, wherein the upper bite plane is parallel with the lower bite plane.

8. The oral apparatus of claim 5, wherein the upper arm extends parallel to the upper bite plane, and the lower arm extends parallel to the lower bite plane.

9. The oral apparatus of claim 1, wherein the lower arm include a corner angle of 90° and the upper arm include a corner angle of 90°.

10. The oral apparatus of claim 1, wherein the upper arm includes an upper arm engagement surface, and the lower arm includes a lower arm engagement surface configured to engage with the upper arm engagement surface to control a vertical positional relationship and a distal positional relationship between the mandible and the maxilla of the patient.

11. The oral apparatus of claim 10, wherein the upper arm engagement surface is parallel with the lower arm engagement surface.

12. An oral apparatus, comprising:
an upper tray configured to receive a plurality of maxillary teeth;
an upper member including an upper base portion coupled to the upper tray and an upper recess;
a lower tray configured to receive a plurality of mandibular teeth; and
a lower member including a lower base portion coupled to the lower tray and a lower interlocking member,
wherein the lower interlocking member is slidingly receivable with the upper recess of the upper member to control a positional relationship between a mandible and a maxilla of a patient.

13. The oral apparatus of claim 12, wherein the lower interlocking member is positioned entirely between a buccal surface and a lingual surface of the lower tray.

14. The oral apparatus of claim 13, wherein the lower interlocking member includes an arm that is cantilevered, wherein the arm extends in a distal direction.

15. The oral apparatus of claim 14, wherein the arm includes an arm engagement surface, and the upper recess includes a recess engagement surface configured to engage with the arm engagement surface to control the positional relationship between the mandible and the maxilla of the patient.

16. The oral apparatus of claim 12, wherein a first surface of the upper base portion defines an upper bite plane, and a second surface of the lower base portion defines a lower bite plane, wherein the upper bite plane engages the lower interlocking member.

17. The oral apparatus of claim 16, wherein an arm of the lower interlocking member slidingly engages the first surface of the upper base portion.

18. The oral apparatus of claim 17, wherein the upper bite plane is parallel with the lower bite plane.

19. The oral apparatus of claim 18, wherein the arm of the lower interlocking member extends parallel to the upper bite plane.

20. An oral apparatus, comprising:
a lower tray configured to receive a plurality of mandibular teeth;
a lower member including a lower base portion coupled to the lower tray and a lower recess;
an upper tray configured to receive a plurality of maxillary teeth; and
an upper member including an upper base portion coupled to the upper tray and an upper interlocking member,
wherein the upper interlocking member is slidingly receivable with the lower recess of the lower member to control a positional relationship between a mandible and a maxilla of a patient.
